(19) United States
(12) Patent Application Publication
(10) Pub. No.: US 2002/0135906 A1
(43) Pub. Date: Sep. 26, 2002

(54) Omnidirectional handlebar reflector insert

(76) Inventor: Richard D. Bonaduce, Salt Lake City, UT (US)

Correspondence Address: Randal D. Homburg, 4th Floor, 50 Penn Place, Oklahoma City, OK, 73118-1803, US

(21) Appl. No.: 10/076,927

(22) Filed: Feb. 15, 2002

Related U.S. Application Data
(60) Provisional application No. 60/277,898, filed on Mar. 23, 2001.

(51) Int. Cl. G02B 5/12; G02B 5/08; G02B 7/18

(52) U.S. Cl. 359/842; 359/550

(57) ABSTRACT

The invention is a reflective insert for bicycles, tricycles or other vehicles having hollow handlebars, the device having an omnidirectional reflective surface attaching to a handlebar plug which, when inserted into the handlebar, provides a reflective surfacing to gather light from multiple directions and reflect such light in an omnidirectional array.

### CROSS REFERENCE TO RELATED APPLICATIONS

Provisional Patent Application No. 60/277,898 filed on Mar. 23, 2001.

### I. BACKGROUND OF INVENTION

1. Field of the Invention

The invention is a reflective insert for bicycles, tricycles or other vehicles having hollow handlebars, the device having an omnidirectional reflective surface attaching to a handlebar plug which, when inserted into the handlebar, provides a reflective surfacing to gather light from multiple directions and reflect such light in an omnidirectional array.

2. Description of Prior Art

The following United States patents are identified and disclosed herein. Several devices are disclosed relating to handlebar inserts with reflective characteristics. For example, in U.S. Pat. No. 5,349,920 to Kiozumi, a dangling reflector or a wind-spun reflector, refractor or light emitter is disclosed attaching to handlebars either in the handlebar grip, from the driver's wrist, or from a suspensory attachment, the device also including a power source for the light emitting embodiment. U.S. Pat. No. 4,715,681 to Johnson discloses an adjustable mirror attaching to a set of handlebars having a multiple direction adjustment to provide the user with a visible capacity for rear view. Reflective domed mirrors are disclosed in U.S. Pat. No. 702,763 to Aurness, the mirrors fitting within the handlebars as inserts providing the driver a means of seeing behind them while riding the bicycle without having to turn around.

### II. SUMMARY OF THE INVENTION

The objective of the current invention is to provide an omnidirectional reflector which is installed in the handlebars of a vehicle having handlebars which gathers light from a multiple number of directions and reflects the gathered light in an omnidirectional array. The device has a removable means of engaging the inner hollow portion of the handlebars with the omnidirectional reflector extending beyond the handlebar in a relatively domed extension, the extension providing a multiple faceted reflective disbursing surface.

### III. DESCRIPTION OF THE DRAWINGS

The following drawings are informal drawings submitted with this provisional patent application.

FIG. 1 is a view of the invention on a set of handlebars.

FIG. 2 is a side view of the invention.

FIG. 3 is a front view of the invention.

FIG. 4 is a side cross-sectional view of the invention.

### IV. DESCRIPTION OF THE PREFERRED EMBODIMENT

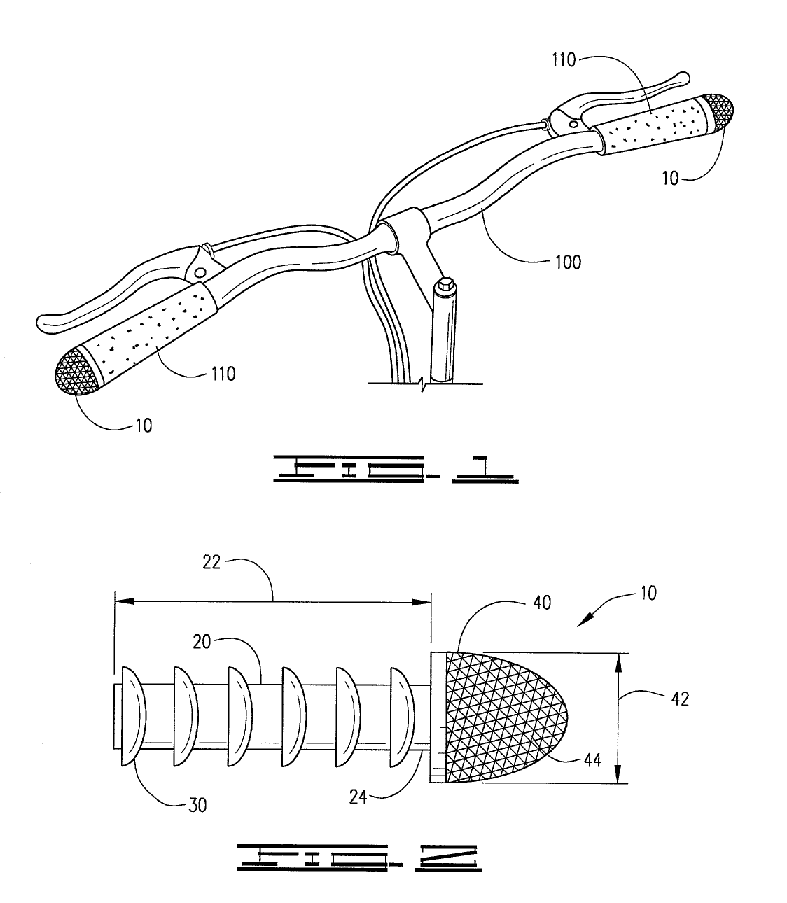

The invention, as shown in FIGS. 1-4 of the drawings, is a device 10 having omnidirectional reflective capacity, inserted and applied to the ends 110 of a bicycle, tricycle or other vehicles having hollow handlebars 100, the invention comprising a cylindrical shaped body 20 having a length 22, a plurality of flexible circular fins 30 in parallel alignment along the length 22 of the body 20 and a hemisphere-shaped reflective cap 40 attached to a first end 24 of the body 20, the hemisphere-shaped reflective cap 40 having a multiplicity of facets 44 comprising the hemisphere-shaped reflective cap 40.

The body 20 and the flexible circular fins 30, as shown in FIGS. 2 and 4 of the drawings, are preferably a rubber or plastic product and are sized to fit within the end 110 of the handlebar 100, the flexible circular fins 30 bending to form a snug internal fit within the handlebar end 110. The hemisphere-shaped reflective cap 40 should be made of a highly reflective material, such hemisphere-shaped reflective cap 40 extending beyond the end 110 of the handlebar 100, as shown in FIG. 1 of the drawings. The hemisphere-shaped reflective cap 40 should be of a diameter 42 to prevent complete insertion of the hemisphere-shaped reflective cap 40 into the handlebar end 110.

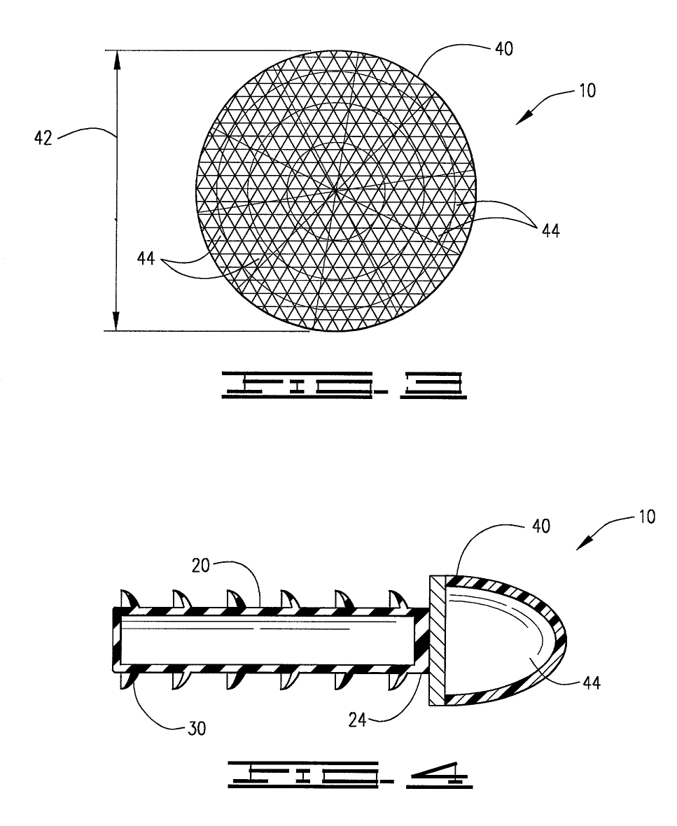

The multiplicity of facets 44 should be arranged in a geometric pattern, as shown by example in FIG. 3 of the drawings, to maximize the potential for gathering light and reflecting such light in an omnidirectional array, providing the greatest reflective exposure from applied light to clearly indicate the presence of the device 10 in the handlebar 100, thus enhancing the recognition of the presence of the vehicle to which the device 10 is applied in the darkness.

Although the embodiments of the invention have been described and shown above, it will be appreciated by those skilled in the art that numerous modifications may be made therein without departing from the scope of the invention as herein described.

What is claimed is:

1. A reflective handlebar insert device having omnidirectional reflective capacity, inserted and applied to the ends of any vehicle having hollow handlebars, the device comprising a cylindrical shaped body having a length, a plurality of flexible circular fins in parallel alignment along the length of the body and a hemisphere-shaped reflective cap attached to a first end of the body, the hemisphere-shaped reflective cap having a multiplicity of facets comprising the hemisphere-shaped reflective cap.

2. The device as disclosed in claim 1, further comprising:
a. the body and the flexible circular fins are made of rubber or plastic and are sized to fit within the end of the handlebar, the flexible circular fins bending to form a snug internal fit within the handlebar end
B. the hemisphere-shaped reflective cap is made of a highly reflective material, such hemisphere-shaped reflective cap extending beyond the end of the handlebar, the hemisphere-shaped reflective cap of a diameter to prevent complete insertion of the hemisphere-shaped reflective cap into the handlebar end.

3. The device as disclosed in claim 1, wherein the multiplicity of facets are arranged in a geometric pattern to maximize the potential for gathering light and reflecting such light in an omnidirectional array, providing the greatest reflective exposure from applied light to clearly indicate the presence of the device in the handlebar, thus enhancing the recognition of the presence of the vehicle to which the device is applied in the darkness.
